(19) United States
(12) Patent Application Publication
(10) Pub. No.: US 2008/0016194 A1
(43) Pub. Date: Jan. 17, 2008

(54) DISPATCHING REQUEST FRAGMENTS FROM A RESPONSE AGGREGATING SURROGATE

(75) Inventors: Madhu Chetuparambil, Raleigh, NC (US); Srinivas Hasti, Raleigh, NC (US); Stephan Hesmer, Holzgerlingen (DE); Todd E. Kaplinger, Raleigh, NC (US); Subbarao K. Meduri, Apex, NC (US); Maxim A. Moldenhauer, Durham, NC (US); Aravind Srinivasan, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/457,937

(22) Filed: Jul. 17, 2006

(51) Int. Cl. G06F 15/173

(52) U.S. Cl. 709/223

(57) ABSTRACT

Embodiments of the present invention address deficiencies of the art in respect to edgified content delivery and provide a method, system and computer program product for dispatching of request fragments from a response aggregating surrogate. In one embodiment, an edgified content distribution data processing system can include an origin server configured to server markup specified pages formed from dynamically arranged fragments and a surrogate server communicatively linked to the origin server over a computer communications network and acting as a surrogate at an edge of the network on behalf of the origin server. A dependency engine can be coupled to the surrogate server and can include program code enabled to group the fragments according to interdependencies among the fragments and to load fragment groups in sequence to satisfy the interdependencies.

### BACKGROUND OF THE INVENTION

1. Field of the Invention

The present invention relates to the field of content assembly for Web applications and more particularly to edgified content distribution for Web applications.

2. Description of the Related Art

Content assembly for Web applications refers to the creation, arrangement and distribution of markup language specified content over a computer communications network. Commonly embodied in the form of a page viewable in a Web browser, markup language content generally includes markup language formatted text, imagery, audiovisual elements and the like, and can be distributed on demand to requesting content browsers. Upon receipt, content browsers can render the markup language specified content for viewing and interaction by end users.

In the most general circumstance, a content server can serve markup to requesting content browsers on demand. For content experiencing higher demand, however, multiple content servers can be arranged in a server cluster in order to balance the load to provide substantial responsiveness for content requesting end users. In the latter circumstance, the server cluster remains centralized. As a result, for geographically dispersed end users, substantial latencies can occur as content is assembled for delivery to end users from afar.

Edgified content distribution refers to a technology family intended to address the problem of geographically dispersed content consumers. In an edgified content distribution network, content is pushed to the edge of the network to be delivered on demand by content consumers closest to the edge of the network. Edgified technologies have proven highly effective and form an integral portion of the content distribution strategy for most content distributors distributing content on a wide scale.

Content that does not change over a long period of time is referred to as static content. Static content can be easily cached for quick delivery to end users via an edgified content delivery network. In contrast, content based upon dynamic, frequently-updated content and personalized or customized content cannot be readily cached due to the changing nature of the content. Dynamic content often is created in a data center within an origin server, in conjunction with a database containing server pages, and an application server configured to combine the foregoing elements in real time to produce the dynamically changing page.

Producing a dynamic page entails substantial processing at the origin server, which must format and deliver the data to the browser. The process of producing a dynamic page can be especially resource consumptive when repeated for every content request, since the processing overhead expended to regenerate an entire page can be very high. A bottleneck can occur as the origin server becomes overwhelmed, resulting in slow downloads or crashes, and ever-growing numbers of servers and load balancers must be deployed to right the balance.

Edge Side Includes (ESI) technology is a specification accepted by the World Wide Web Consortium (W3C) that describes a means to push dynamic content from the origin server to multiple edge servers, closer to the end user. Offloading the burden of content assembly from the origin server to surrogate servers at the edge of the network increases content download speed and limits crashes because the origin server need not redesign pages each time a page element is updated—a process that doesn't scale to handle large numbers of simultaneous users.

ESI has proven effective in assembly pages from content fragments generally where the interrelationship between fragments matters little in the assembly of a page. Notwithstanding, more complex pages include interdependent fragments. By interdependent, it is meant that the rendering of one fragment may depend upon the prior resolution of another fragment. In this circumstance, the rendering of a complete page can be hindered by the need to sequentially resolve dependencies. Thus, the sequential nature of fragment assembly can result in the loss of any advantage achieved in the use of ESI at the edge of the network.

### BRIEF SUMMARY OF THE INVENTION

Embodiments of the present invention address deficiencies of the art in respect to edgified content delivery and provide a novel and non-obvious method, system and computer program product for dispatching of request fragments from a response aggregating surrogate. In one embodiment of the invention, an edgified content distribution data processing system can be provided. The system can include an origin server configured to server markup specified pages formed from dynamically arranged fragments and a surrogate server communicatively linked to the origin server over a computer communications network and acting as a surrogate at an edge of the network on behalf of the origin server.

A dependency engine can be coupled to the surrogate server. The dependency engine can include program code enabled to group the fragments according to interdependencies among the fragments and to load fragment groups in sequence to satisfy the interdependencies. Also, the program code of the dependency engine can be further enabled to determine the interdependencies from dependency data provided by the origin server.

In another embodiment of the invention, a dynamic page assembly method can be provided. The method can include identifying a selection of fragments for assembly into a dynamic page on behalf of an origin server, grouping the fragments into fragment groups based upon dependency relationships between selected ones of the fragments, aggregating the fragment groups into the dynamic page in a sequence defined to satisfy the dependency relationships, and serving the page to a content requesting client on behalf of the origin server. The method further can include receiving dependency data from the origin server that defines the dependency relationships for the selection of fragments.

Grouping the fragments into fragment groups based upon dependency relationships between selected ones of the fragments can include grouping the fragments in the selection of fragments into fragment groups so as to identify those among the selection of fragments whose presence in the dynamic page are depended upon by others of the selection of fragments. Also, aggregating the fragment groups into the dynamic page in a sequence defined to satisfy the dependency relationships can include retrieving and aggregating each fragment in a fragment group in parallel.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an edgified content distribution data processing system configured for dispatching request fragments from a response aggregating surrogate; and,

FIG. 2 is a flow chart illustrating a process for dispatching request fragments from a response aggregating surrogate.

### DETAILED DESCRIPTION OF THE INVENTION

Embodiments of the present invention provide a method, system and computer program product for dispatching request fragments from a response aggregating surrogate. In accordance with an embodiment of the present invention, dependency information for fragments in a dynamically assembled page can be determined and provided to a surrogate server in the edgified network. A dependency engine coupled to the surrogate server can use the dependency information to order the loading of each of the fragments, in parallel groups where appropriate in order both to assure the presence of dependencies for dependant fragments and also to enhance performance through parallel fragment loads where possible.

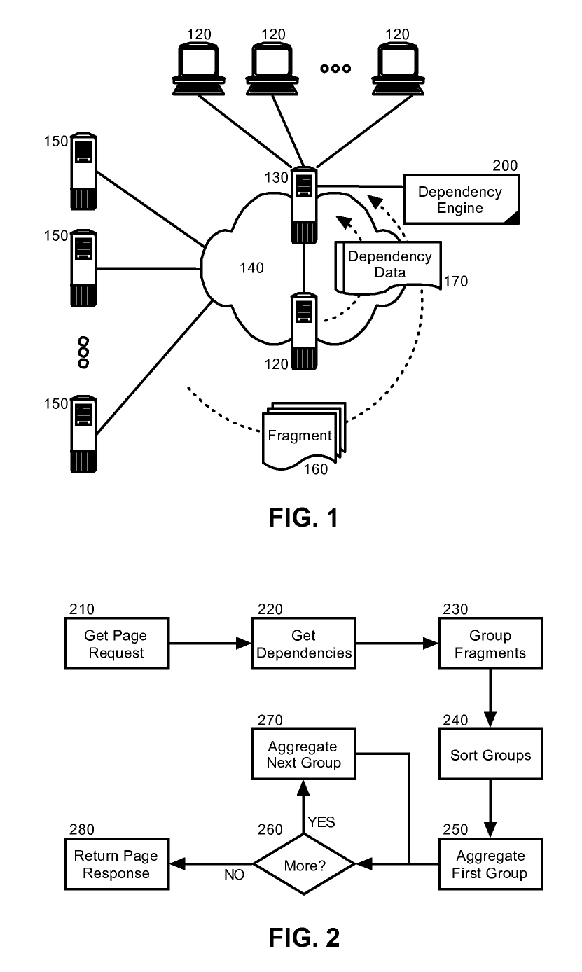

In further illustration, FIG. 1 is a schematic illustration of an edgified content distribution data processing system configured for dispatching request fragments from a response aggregating surrogate. The system can include an origin server 120 configured to serve requested content to one or more content requesting clients 120 over a computer communications network 140. In order to enhance the speed in which content can be delivered to the content requesting clients 120, the origin server 120 can be coupled to a surrogate server 130 at the edge of the computer communications network 140. The surrogate server 130 can be configured to serve requested content to the content requesting clients 120 on behalf of the origin server 120.

Notably, the surrogate server 130 can be configured to assemble dynamic pages for delivery to the content requesting clients 120 in response to content requests from the content requesting clients 120. The dynamic pages can include a set of fragments 160 provided by one or more fragment sources 150 also communicatively coupled to the surrogate server 130 over the computer communications network 140. Each of the fragments 160 can be arranged to form the dynamic page. At least one of the fragments 160, however, can depend on the presence of at least one other of the fragments 160.

In this regard, a dependency hierarchy can be defined by the fragments 160 in accordance with the interdependent relationships among the fragments 160. To facilitate the loading of dependent ones of the fragments in proper order, without resorting to a sequential loading of the fragments 160, dependency data 170 provided by the origin server 120 can be processed in a dependency engine 200. The dependency engine can include program code enabled to group different ones of the fragments 160 for loading in sequence so as to satisfy the dependencies of the fragments 160 while achieving some parallel loading of others of the fragments 160.

In more particular illustration, FIG. 2 is a flow chart illustrating a process for dispatching request fragments from a response aggregating surrogate. Beginning in block 210, a page request can be received for a dynamically constructed page defined by multiple different fragments. In block 220, the dependencies of the different fragments in the dynamically constructed page can be determined and in block 230, the different fragments can be grouped in order of dependant relationships. For example, in a page of four fragments labeled A, B, C and D, if B depends upon the presence of C and D, then C and D can be grouped together for loading in parallel, followed by A and B which also can be loaded in parallel after A and B.

In block 240, the groups can be sorted in proper sequence to ensure that those fragments that are depended upon by other fragments are loaded prior to the other fragments. Thereafter, in block 250, the first group to be loaded can be retrieved and aggregated. In decision block 260, if additional groups remain to be loaded, in block 270 the next group to be loaded can be retrieved and aggregated. This process can continue for all fragment groups. When no additional fragment groups remain to be aggregated, in block 280 the dynamically aggregated page can be returned to the content requester for rendering. In this way, the dependency requirements of the fragments can be fulfilled during aggregation while allowing for some efficiencies in parallel loading portions of the fragments.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An edgified content distribution data processing system comprising:
an origin server configured to server markup specified pages formed from dynamically arranged fragments;
a surrogate server communicatively linked to the origin server over a computer communications network and acting as a surrogate at an edge of the network on behalf of the origin server; and,
a dependency engine coupled to the surrogate server, the dependency engine comprising program code enabled to group the fragments according to interdependencies among the fragments and to load fragment groups in sequence to satisfy the interdependencies.

2. The data processing system of claim 1, wherein the program code of the dependency engine is further enabled to determine the interdependencies from dependency data provided by the origin server.

3. A dynamic page assembly method comprising:
identifying a selection of fragments for assembly into a dynamic page on behalf of an origin server;
grouping the fragments into fragment groups based upon dependency relationships between selected ones of the fragments;
aggregating the fragment groups into the dynamic page in a sequence defined to satisfy the dependency relationships; and,
serving the page to a content requesting client on behalf of the origin server.

4. The method of claim 3, further comprising receiving dependency data from the origin server that defines the dependency relationships for the selection of fragments.

5. The method of claim 3, wherein grouping the fragments into fragment groups based upon dependency relationships between selected ones of the fragments, comprises grouping the fragments in the selection of fragments into fragment groups so as to identify those among the selection of fragments whose presence in the dynamic page are depended upon by others of the selection of fragments.

6. The method of claim 3, wherein aggregating the fragment groups into the dynamic page in a sequence defined to satisfy the dependency relationships, comprises retrieving and aggregating each fragment in a fragment group in parallel.

7. A computer program product comprising a computer usable medium embodying computer usable program code for dynamic page assembly, the computer program product including:
computer usable program code for identifying a selection of fragments for assembly into a dynamic page on behalf of an origin server;
computer usable program code for grouping the fragments into fragment groups based upon dependency relationships between selected ones of the fragments;
computer usable program code for aggregating the fragment groups into the dynamic page in a sequence defined to satisfy the dependency relationships; and,
computer usable program code for serving the page to a content requesting client on behalf of the origin server.

8. The computer program product of claim 7, further comprising computer usable program code for receiving dependency data from the origin server that defines the dependency relationships for the selection of fragments.

9. The computer program product of claim 7, wherein the computer usable program code for grouping the fragments into fragment groups based upon dependency relationships between selected ones of the fragments, comprises computer usable program code for grouping the fragments in the selection of fragments into fragment groups so as to identify those among the selection of fragments whose presence in the dynamic page are depended upon by others of the selection of fragments.

10. The computer program product of claim 7, wherein the computer usable program code for aggregating the fragment groups into the dynamic page in a sequence defined to satisfy the dependency relationships, comprises computer usable program code for retrieving and aggregating each fragment in a fragment group in parallel.
